(19) United States
(12) Patent Application Publication
(10) Pub. No.: US 2019/0173255 A1
(43) Pub. Date: Jun. 6, 2019

(54) Laser Diode Device and a Projector Using Same

(71) Applicant: INUITIVE LTD., Ra'anana (IL)

(72) Inventor: Hassid Costa GURGOV, Or Akiva (IL)

(21) Appl. No.: 16/202,779

(22) Filed: Nov. 28, 2018

Related U.S. Application Data
(60) Provisional application No. 62/593,890, filed on Dec. 2, 2017.

(51) Int. Cl. H01S 3/00; G03B 21/20; G02B 27/30; G02B 27/09

(52) U.S. Cl. CPC H01S 3/0085; G02B 27/0955; G02B 27/30; G03B 21/2033

(57) ABSTRACT

A laser device comprising two lenses, each of which is configured to separately collimate radiant electromagnetic energy in a respective axis, wherein one of the two lenses is a fast-axis collimating (FAC) lens and the other of the two lenses is a slow axis collimating (SAC) lens, and wherein the SAC lens is characterized in that it has a first surface being a negative surface and a second surface being a positive surface.

### TECHNICAL FIELD

The present disclosure generally relates to the field of optical devices, and more particularly, to collimation of laser diodes.

### BACKGROUND

The process by which a beam of radiant electromagnetic energy is directed to minimize divergence or convergence, is called collimation. A collimated beam is an electromagnetic field having a narrow angular spectrum, that may be represented by a bundle of parallel rays lined up along an optical axis.

Collimation of laser diodes requires precise and small optical components, accurately placed relative to the laser diode aperture. Laser diode (hereinafter “LD”) can be single-mode or multimode, where the latter is capable of delivering much higher power.

FIG. 1 presents a prior art solution where a single-mode laser diode is collimated using a single axisymmetric lens. The aperture of multimode LDs in the horizontal (hereinafter “slow-axis”) direction is substantially longer than in single-mode LDs, up to 3 orders of magnitude, whereas in the vertical (hereinafter “fast-axis”) direction, the dimension is similar. Due to the physics of light confinement and diffraction theory, light emitted from a multimode LD diverges from the aperture in the fast-axis direction at a substantially larger angle than its divergence in the slow-axis direction. The implication on multimode LD collimation is that in order to reach a high enough degree of collimation for the slow axis, a much longer focal length is required (roughly proportionally to aperture length). For simple collimating lenses as depicted in FIG. 1, this would mean that such a lens will have to be located at a larger distance from the laser aperture, and consequently making the collimated laser assembly longer. At the same time, due to the high light divergence angle in the fast-axis plane (typically 24-60 degrees full angle), the fast-axis beam width is very large, which requires a large lens and in turn will make the laser module assembly diameter much larger than desired. In order to avoid this difficulty, the lens' function is divided into separate axes, as shown in FIGS. 2A, 2B, and 3. Namely, instead of having a circularly-symmetric lens, a fast-axis collimating lens (hereinafter “FAC”) and a slow-axis collimating lens (hereinafter “SAC”) are used. The FAC is located close to the laser aperture, whereas the SAC is located further away, allowing a long enough focal length. Unfortunately, even though this allows reducing the lens size and the module diameter, still, the module is much longer than often desired.

### SUMMARY OF THE DISCLOSURE

The disclosure may be summarized by referring to the appended claims.

It is an object of the present disclosure to provide a novel solution that enables collimation of light emitted from a laser diode, while using low-cost and compact components, preferably by using a geometrical structure that enables locating these components with short distances there-between, thereby limiting air gaps that exist between these components, and in particularly, for multimode laser diodes (LDs).

It is another object of the present disclosure to provide a solution whereby near-collimation of laser diodes is obtainable.

It is another object of the present disclosure to provide a solution whereby light emitted from a laser device converges to a focal area of a desired size.

It is another object of the present disclosure to provide an optical projecting module that comprises such a laser device.

It is another object of the present disclosure to provide near-collimation of laser diodes, or ones that direct light to converge to a focus.

Other objects of the present invention will become apparent from the following description.

According to a first embodiment of the disclosure, there is provided a laser device (e.g. a multimode laser diode) that comprises two lenses, each of which is configured to separately collimate radiant electromagnetic energy in a respective axis, wherein one of the two lenses is a fast-axis collimating (FAC) lens and the other of the two lenses is a slow axis collimating (SAC) lens, and wherein the SAC lens is characterized in that it has a first surface being a negative surface and a second surface being a positive surface.

An optical surface may be positive or negative—depending on the degree of divergence/convergence that the oncoming incident rays undergo, upon hitting that surface.

The term “positive surface” as used herein throughout the specification and claims with respect to a lens, is used to denote a surface which has positive optical power with respect to the incident rays' field (i.e. having a converging property with a positive effective focal length).

The term “negative surface” as used herein throughout the specification and claims with respect to a lens, is used to denote a surface which has a negative optical power with respect to the incident rays' field (i.e. having a diverging property with a negative effective focal length).

According to another embodiment, the SAC lens is characterized in that it has a long effective focal length (EFL) and a short back focal length (BFL).

In accordance with another embodiment, the SAC lens of the laser device is made of one or a combination of individual lenses, wherein in the latter case they may be made of the same material or made of different materials, e.g. glass or of a polymeric material, and the like.

By another embodiment, the SAC lens optical surfaces affect the fast-axis, e.g. in improving collimation quality of the beam.

By yet according to another embodiment, the FAC lens of the laser device is provided with one or more reference surfaces. Preferably, the SAC lens is passively aligned relative to the FAC lens.

In accordance with still another embodiment, the FAC and SAC lenses are configured to enable alignment of the SAC lens relatively to the FAC lens by positioning the SAC lens in direct contact with the one or more reference surfaces of the FAC lens. Alternatively, by positioning the SAC lens in indirect contact with the one or more reference surfaces of the FAC lens, e.g. by having spacers that separate between the SAC lens and the FAC lens. Optionally, the spacers may be part of a housing barrel.

According to another embodiment, the laser device further comprises an intermediate folding surface and wherein the laser device is configured to enable carrying out a fast-axis collimation by deploying a separate lens. The folding surface may be implemented for example as a reflective surface between FAC and SAC lenses.

In accordance with another aspect of the disclosure there is provided a projector comprising a laser device described hereinabove and a pattern-generating optical component.

By yet another embodiment of this aspect of the disclosure the pattern-generating optical component is a Diffractive Optical Element (“DOE”).

### BRIEF DESCRIPTION OF THE DRAWINGS

For a more complete understanding of the present invention, reference is now made to the following detailed description taken in conjunction with the accompanying drawing wherein:

FIG. 1—illustrates an example of a prior art device where laser diode collimation is carried out by using a single lens;

FIG. 2—exemplify a prior art device implementing FAC and SAC lenses in a laser device. FIG. 2A illustrates a top view of the laser device while FIG. 2B illustrates a side view thereof;

FIG. 3—demonstrates an isometric view of a prior art device where a fast-axis collimating lens and a slow axis collimating lens are presented in an operating condition;

FIG. 4—illustrate two views of a laser device construed in accordance with an embodiment of the present invention wherein its slow axis collimating (SAC) lens is concave-convex;

FIG. 5—demonstrate a laser device construed in accordance with an embodiment of the present invention wherein its FAC lens and SAC lens are passively aligned, relative to each other; and

FIG. 6—demonstrates an embodiment of FAC and SAC lenses, where the SAC lens is wrapped around a folding surface.

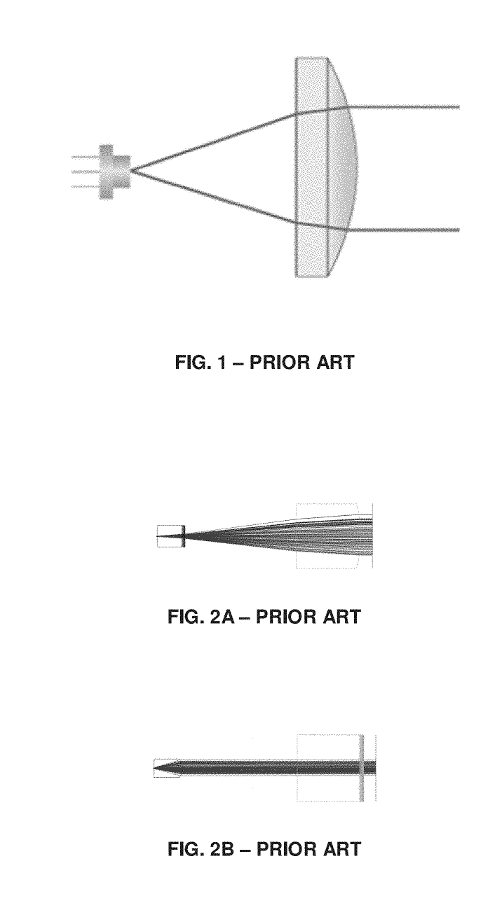

### DETAILED DESCRIPTION

In this disclosure, the term “comprising” is intended to have an open-ended meaning so that when a first element is stated as comprising a second element, the first element may also include one or more other elements that are not necessarily identified or described herein, or recited in the claims.

In the following description, for the purposes of explanation, numerous specific details are set forth in order to provide a better understanding of the present invention by way of examples. It should be apparent, however, that the present invention may be practiced without these specific details.

Multimode laser diodes have a light emitting aperture which is asymmetric, e.g. being substantially longer in one dimension than the other. Typically, the dimensions of a 500 mW multimode laser diode's aperture at NIR wavelength are about 3 μm in one direction and a few tens or hundreds of microns in the other direction. The direction associated with the shorter aperture dimension, is referred to as the fast axis, since light in that direction diverges rapidly at high angles. In the other direction (referred to as the slow axis), light conveyed along this axis diverges at low angles, thereby producing an elliptical beam. In many applications, it is important to transform the LD's diverging light into a collimated beam, having divergence of less than a certain pre-defined angle, such as 2 milliradians. In order to achieve divergence that is below the pre-defined angle, the lens should have a certain focal length which is roughly proportional to the aperture size. As known in the art, for multimode LDs which have very different aperture widths in the two transverse axes, two separate lenses are used, which are typically made of glass, a fast-axis collimating (“FAC”) lens and a slow axis collimating (“SAC”) lens. The SAC lens (typically a plano-convex lens) acts on the longer dimension of the aperture, thus has a substantially longer effective focal length (“EFL”) than the FAC, sometimes by a factor of 10. Consequently, as the SAC lens is positioned at a distance of back focal length (“BFL”) away from the laser diode, the laser module is much longer than often desired, since for simple (e.g. plano-convex or biconvex) lenses having a diameter that is at least a few times smaller than the EFL, the BFL value is close to the EFL value.

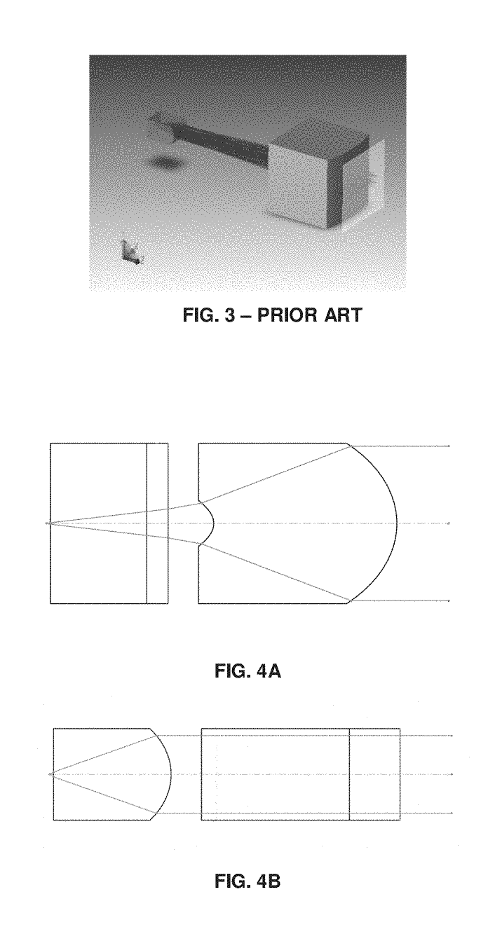

FIGS. 2A and 2B exemplify an implementation of FAC and SAC lenses of a prior art laser device described above. FIG. 2A illustrates a top view of the laser device while FIG. 2B illustrates a side view thereof, a laser device which comprises a set of two lenses that collimate the two axes of the laser separately. As may be noted from FIG. 2, the laser diode aperture is located very close to the planar side of FAC lens, yet at a substantial distance from the SAC lens. FIG. 3 demonstrates an isometric view of a fast-axis collimating lens and a slow axis collimating lens, in operation.

According to the solution provided by an embodiment of the present invention, the SAC lens is made of a polymeric material or a combination of polymeric materials.

Now, since the cost of glass lenses is high, as opposed to plastic lenses which, at large quantities, are substantially cheaper, obviously the solution provided by the present invention offers an economical advantage over the prior art laser devices.

FIGS. 4A and 4B illustrate two views of a laser device construed in accordance with the present invention having a slow axis collimating (SAC) lens that is in a concave-convex shape, such that the incident beam meets the negative surface having negative optical power and then the positive surface having positive optical power, which together provide a structure of a high EFL, but a short BFL. The surfaces of the lens are a-cylindrical, i.e. aspherical cylinder.

Now, let us take the following example:

Lens material: Zeonex F52R
Lens thickness: 4 mm

| Surface | Radius R | Conic k |
|---|---|---|
| S1 | −0.36 | −1.077 |
| S2 | −1.66 | −0.509 |

In accordance with the Sag equation:

$$z ( r ) = \frac{{r}^{2}}{R ( 1 + \sqrt{1 - ( 1 + κ ) \frac{{r}^{2}}{{R}^{2}}} )} + {α}_{4} {r}^{4} + {α}_{6} {r}^{6} + …$$

By this example, the value of the EFL is 14.77 mm, whereas the value of the BFL is 3.7 mm.

For comparison, a conventional plano-convex glass SAC lens would have an EFL value of 12.3 mm, a BFL value of 10.9 mm and a thickness of 2 mm.

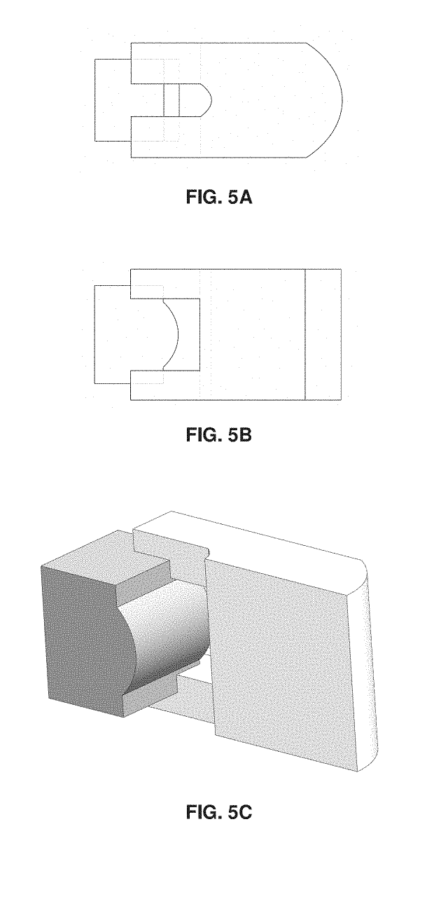

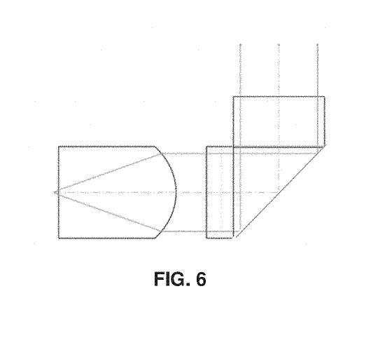

FIGS. 5A to 5C relate to an embodiment where the FAC lens of the laser device is provided with one or more reference surfaces. Such one or more reference surfaces enable alignment of the SAC lens relative to the FAC lens, by positioning the SAC lens in direct contact with the one or more reference surfaces of the FAC lens, or by positioning the SAC lens in indirect contact with the one or more reference surfaces of the FAC lens, e.g. by having spacers that separate between the SAC lens and the FAC lens. For clarity, FIG. 5C illustrates an isometric cross section of the SAC lens.

FIG. 6 demonstrates an embodiment where the SAC lens is wrapped around a folding prism, an embodiment which may be useful for applications where collimated beam direction is required to be normal to the plane on which the laser diode is mounted. As will be appreciated by those skilled in the art, the folding surface may be implemented as a reflective surface between FAC and SAC lenses, or by having a folding surface in the SAC lens, as shown in FIG. 6.

Thus, some of the advantages which are offered by the solution provided by the present invention may be summarized as follows:

a. The solution enables obtaining a smaller collimated laser module.

b. The solution offers using a cheaper SAC lens for the laser device.

c. According to one of the embodiments of the invention, the solution enables a passive alignment of SAC lens.

d. According to one of the embodiments of the solution, the beam may be folded between FAC and SAC lenses or within the SAC lens.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

The present invention has been described using detailed descriptions of embodiments thereof that are provided by way of example and are not intended to limit the scope of the invention in any way. The described embodiments comprise different objects, not all of which are required in all embodiments of the invention. Some embodiments of the present invention utilize only some of the objects or possible combinations of the objects. Variations of embodiments of the present invention that are described and embodiments of the present invention comprising different combinations of features noted in the described embodiments will occur to persons of the art. The scope of the invention is limited only by the following claims.

1. A laser device comprising two lenses, each of which is configured to separately collimate radiant electromagnetic energy in a respective axis, wherein one of the two lenses is a fast-axis collimating (FAC) lens and the other of the two lenses is a slow axis collimating (SAC) lens, and wherein the SAC lens is characterized in that it has a first surface being a negative surface and a second surface being a positive surface.

2. The laser device of claim 1, wherein said SAC lens is characterized by having a long effective focal length (EFL) and a short back focal length (BFL).

3. The laser device of claim 1, wherein the SAC lens is made of one or a combination of individual lenses.

4. The laser device of claim 3, wherein the SAC lens is made of a combination of individual lenses, wherein each of the different lenses is made of a material being different from a material of which another lens is made.

5. The laser device of claim 1, wherein the FAC lens is provided with one or more reference surfaces, and wherein the SAC lens is passively aligned relative to the FAC lens.

6. The laser device of claim 5, wherein the FAC and SAC lenses are configured to enable alignment of the SAC lens relatively to the FAC lens by positioning the SAC lens in direct contact with the one or more reference surfaces of the FAC lens, or by positioning the SAC lens in indirect contact with the one or more reference surfaces of the FAC lens, by having spacers that separate between the SAC lens and the FAC lens.

7. The laser device of claim 1, further comprising an intermediate folding surface and wherein said laser device is configured to enable carrying out a fast-axis collimation by implementing a separate lens.

8. A projector comprising a laser device of claim 1 and a pattern-generating optical component.

9. The projector of claim 8, wherein said pattern-generating optical component is a Diffractive Optical Element (DOE).
